(19) United States
(12) Patent Application Publication
(10) Pub. No.: US 2022/0099979 A1
(43) Pub. Date: Mar. 31, 2022

(54) DIFFRACTION OPTICAL MEMBER AND VIRTUAL IMAGE DISPLAY DEVICE

(71) Applicant: SEIKO EPSON CORPORATION, Tokyo (JP)

(72) Inventor: Hiroyuki TATSUGI, Chino-shi (JP)

(73) Assignee: SEIKO EPSON CORPORATION, Tokyo (JP)

(21) Appl. No.: 17/487,826

(22) Filed: Sep. 28, 2021

(30) Foreign Application Priority Data
Sep. 29, 2020 (JP) 2020-162916

(51) Int. Cl. G02B 27/01; G02B 27/42

(52) U.S. Cl. CPC G02B 27/0172; G02B 2027/0178; G02B 2027/0174; G02B 27/4277

(57) ABSTRACT

A diffraction optical member includes a first substrate having moisture permeability, a first dielectric film provided at one surface of the first substrate, a hologram element provided at the first dielectric film, a second substrate provided facing the hologram element, and an adhesive member configured to adhere the first substrate to the second substrate to form an accommodation space that accommodates the hologram element.

The present application is based on, and claims priority from JP Application Serial Number 2020-162916, filed Sep. 29, 2020, the disclosure of which is hereby incorporated by reference herein in its entirety.

### BACKGROUND

### 1. Technical Field

The present disclosure relates to a diffraction optical member and a virtual image display device.

### 2. Related Art

There has been a head-mounted display (HMD) as a virtual image display device that causes a user to visually recognize an image. In general, the head-mounted display includes an image formation unit that forms image light and a visual recognition unit that emits the image light formed by the image formation unit to an eye (a pupil) of the user by deflecting the image light, and can cause the user to simultaneously visually recognize both of an outside scene and the image light by the image formation unit through the visual recognition unit.

For example, WO 2017/013971 discloses a head-mounted display including a hologram element as a visual recognition unit. In the head-mounted display, a moisture absorption member is arranged along with the hologram element in an accommodation space formed of a pair of substrates and a sealing member.

However, in the head-mounted display of WO 2017/013971, it is difficult to sufficiently absorb moisture that enters the accommodation space, and the hologram element expands due to an influence of the moisture, and thus there is a problem that a deflection characteristic is degraded.

### SUMMARY

In order to solve the problem described above, an aspect of the present disclosure provides a diffraction optical member including a first substrate having moisture permeability, a first dielectric film provided at one surface of the first substrate, a hologram element provided at the first dielectric film, a second substrate provided facing the hologram element, and an adhesive member configured to adhere the first substrate to the second substrate to form an accommodation space that accommodates the hologram element.

An aspect of the present disclosure provides a diffraction optical member including a first substrate, a first dielectric film provided at one surface of the first substrate, a hologram element provided at the first dielectric film, a second substrate provided facing the hologram element, a second dielectric film provided at a surface of the second substrate facing the hologram element, and an adhesive member configured to adhere the first substrate to the second substrate to form an accommodation space that accommodates the hologram element, where at least one of an inert substance and an air layer is provided in the accommodation space.

An aspect of the present disclosure provides a virtual image display device including the diffraction optical member according to the aspect described above.

### BRIEF DESCRIPTION OF THE DRAWINGS

FIG. 1 is a schematic perspective view of a head-mounted display according to a first exemplary embodiment.

FIG. 2 is a plan view when the head-mounted display is viewed from above.

FIG. 3 is an enlarged plan view of an image display device of the head-mounted display.

FIG. 4 is an enlarged side view of the image display device of the head-mounted display.

FIG. 5 is a cross-sectional view illustrating a schematic configuration of a diffraction optical member.

FIG. 6 is a diagram illustrating a method for manufacturing a hologram element.

FIG. 7 is a diagram illustrating the method for manufacturing the hologram element.

FIG. 8 is a schematic view illustrating a method for exposing the hologram element.

FIG. 9 is a schematic view illustrating a pattern of an interference stripe of the hologram element.

FIG. 10 is a schematic view illustrating the pattern of the interference stripe of the hologram element.

FIG. 11 is a diagram illustrating steps of manufacturing the diffraction optical member.

FIG. 12 is an explanatory diagram of the size of the hologram element that occupies the diffraction optical member.

FIG. 13 is a cross-sectional view illustrating a schematic configuration of a diffraction optical member according to a second exemplary embodiment.

FIG. 14 is a cross-sectional view illustrating a schematic configuration of a diffraction optical member according to a third exemplary embodiment.

FIG. 15 is a diagram illustrating a step of manufacturing the diffraction optical member.

FIG. 16 is a cross-sectional view illustrating a schematic configuration of a diffraction optical member according to a fourth exemplary embodiment.

### DESCRIPTION OF EXEMPLARY EMBODIMENTS

Exemplary embodiments of a diffraction optical member and a virtual image display device according to the present disclosure will be described below with reference to the accompanying drawings.

Note that, in the drawings used for the following descriptions, characteristic portions are expanded for convenience to make characteristics easily comprehensible in some cases, thus dimension ratios among respective constituent elements or the like are not necessarily the same as actual dimension ratios.

### First Exemplary Embodiment

First, before description of the diffraction optical member according to the present disclosure, the virtual image display device including the diffraction optical member according to the present disclosure will be described. The virtual image display device according to this exemplary embodiment is a see-through type head-mounted display (HMD) with which an image and an external world are visible. In other words, the virtual image display device causes a user to recognize an image as a virtual image, and causes the user to observe an external world image as see-through light.

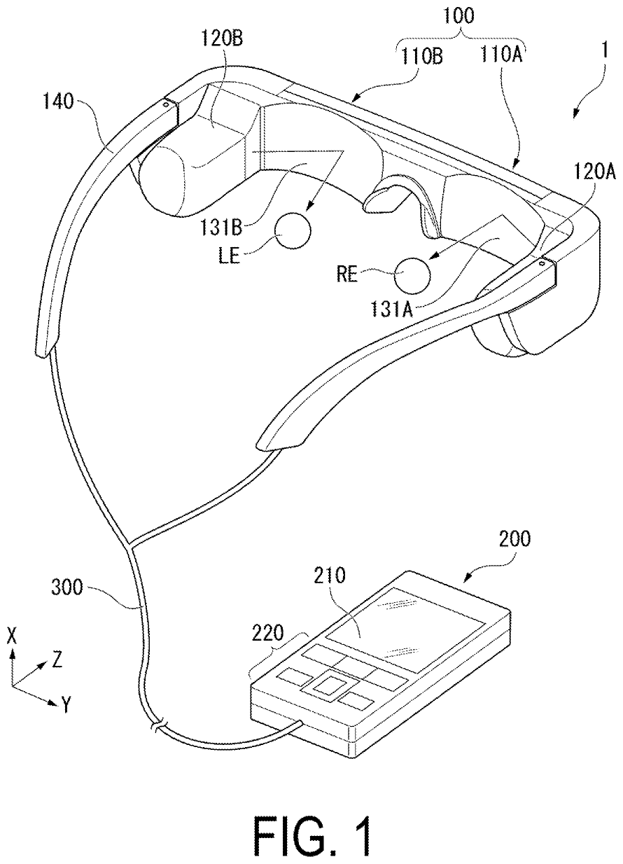

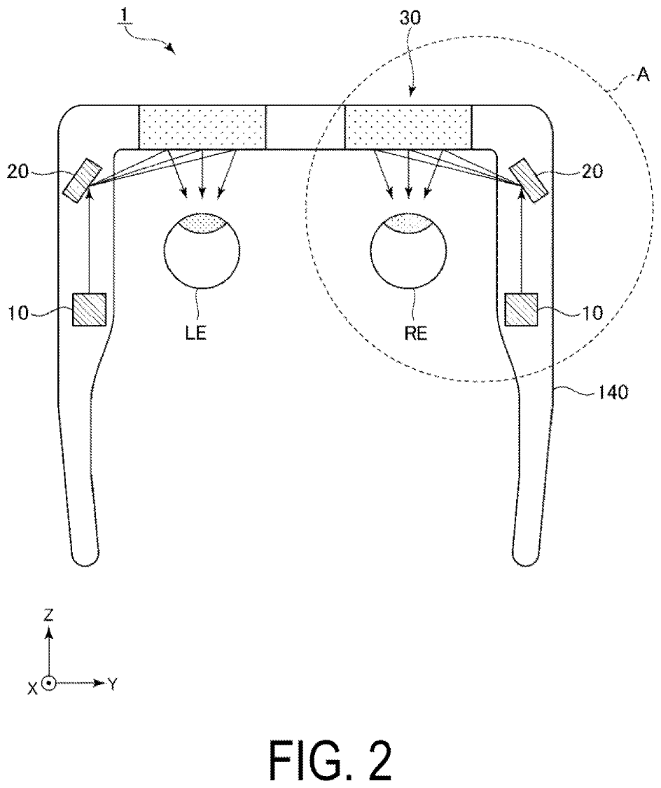

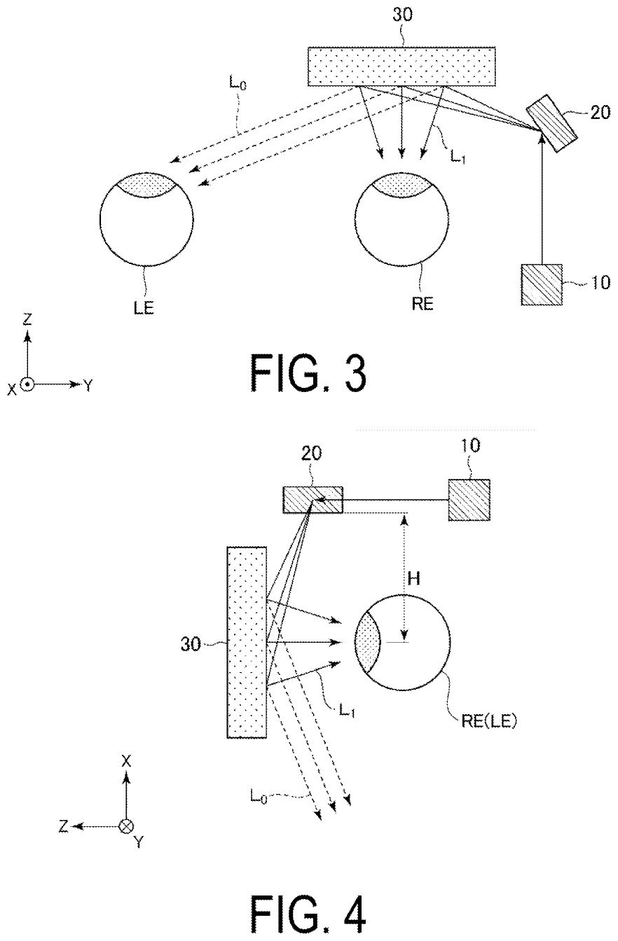

FIG. 1 is a schematic perspective view illustrating an overall configuration of the head-mounted display according to this exemplary embodiment. FIG. 2 is a plan view when the head-mounted display illustrated in FIG. 1 is viewed from above. FIG. 3 is a schematic plan view illustrating a configuration of an image display device in a part A of the head-mounted display illustrated in FIG. 2 in an enlarged manner. FIG. 4 is a schematic side view illustrating the configuration of the image display device in the part A of the head-mounted display illustrated in FIG. 2 in an enlarged manner.

Note that, in the drawings illustrated below, an arrangement of each member will be described by using an XYZ coordinate system.

For example, in FIG. 2, an upper side, a lower side, a sheet front side, a sheet depth side, a right side, and a left side are referred to as “front (Z direction)”, “rear (−Z direction)”, “upper (X direction)”, “lower (−X direction)”, “right (Y direction)”, and “left (−Y direction),” respectively. In other words, in the following description, a longitudinal direction of a diffraction optical member 30 described later (height direction of a frame 140), a transverse direction of the diffraction optical member 30 (width direction of a visual recognition unit 131A), and a thickness direction of the diffraction optical member 30 (thickness direction of the visual recognition unit 131A) are indicated as “±X direction”, “±Y direction”, and “±Z direction”, respectively.

As illustrated in FIG. 1, a head-mounted display 1 includes a main body unit 100 having a shape of glasses and a control unit 200 having the size holdable by a hand of a user.

In this exemplary embodiment, the main body unit 100 and the control unit 200 are coupled by a cable 300 to be communicable with each other by wire. Further, the main body unit 100 and the control unit 200 transmit an image signal and a control signal through the cable 300. Note that, the main body unit 100 and the control unit 200 are only required to be coupled to be communicable, and may be coupled by wire as illustrated in FIG. 1 or by wireless.

The main body unit 100 includes a right-eye display unit 110A and a left-eye display unit 110B. The right-eye display unit 110A includes an image formation unit 120A for forming image light for a right-eye image. The left-eye display unit 110B includes an image formation unit 120B for forming image light for a left-eye image.

In the frame 140 of the main body unit 100 having the shape of glasses, the image formation unit 120A is accommodated in a temple portion (right side) of the glasses. In the frame 140 of the main body unit 100 having the shape of glasses, the image formation unit 120B is accommodated in a temple portion (left side) of the glasses.

The visual recognition unit 131A being light transmissive is provided at a position corresponding to a lens (right side) of the glasses in the main body unit 100. The visual recognition unit 131A emits the image light for the right-eye image to a right eye RE (one eye) of the user. Further, in the head-mounted display 1, the visual recognition unit 131A is light transmissive, and the right eye RE can visually recognize a periphery through the visual recognition unit 131A.

Further, a visual recognition unit 131B being light transmissive is provided at a position corresponding to a lens (left side) of the glasses in the main body unit 100. The visual recognition unit 131B emits the image light for the left-eye image to a left eye LE (the other eye) of the user. Further, in the head-mounted display 1, the visual recognition unit 131B is light transmissive, and the left eye LE can visually recognize the periphery through the visual recognition unit 131B.

As described above, in this exemplary embodiment, the head-mounted display 1 is an augmented reality (AR) type HMD enabling the right eye RE and the left eye LE to visually recognize the see-through light of the periphery through the visual recognition units 131A and 131B.

The control unit 200 includes an operation unit 210 and an operation button unit 220. The user performs operation input with respect to the operation unit 210 and the operation button unit 220 of the control unit 200, and gives instructions to respective components included in the main body unit 100.

As illustrated in FIG. 2, in the head-mounted display 1 having the configuration described above, each of the image formation unit 120A arranged (accommodated) in the temple portion (right side) of the frame 140 and the image formation unit 120B arranged in the temple portion (left side) of the frame 140 includes a light source 10 and a scanning mirror 20.

Furthermore, each of the visual recognition unit 131A provided at the position corresponding to the lens (on the right side) and the visual recognition unit 131B provided at the position corresponding to the lens (on the left side) includes the diffraction optical member 30 for displaying an image on a retina of the right eye RE and the left eye LE of the user.

In this exemplary embodiment, each light source 10 emits semiconductor laser light being laser light obtained by combining laser light from a red laser light source, laser light from a blue laser light source, and laser light from a green laser light source. Further, any color of laser light is output by properly modulating an output from each color laser light source. Furthermore, an image can be displayed on the retina of the eye of the user by performing modulation in association with the scanning mirror 20 and the like described later.

Each scanning mirror 20 includes a mirror and an oscillation control unit for controlling oscillation of the mirror with a certain frequency. The oscillation control unit is formed of, for example, an MEMS. Constituting the oscillation control unit by the MEMS as described above enables downsizing of the scanning mirror 20.

Note that, in place of the light source 10 and the scanning mirror 20, each of the image formation units 120A and 120B may include an image display element that emits the image light containing image information and a reflecting mirror that guides the emitted image light to the diffraction optical member 30 and causes the emitted image light to enter. Further, in this case, the image display element is not particularly limited as long as the image display element can emit the image light containing the image information. Examples of the image display element include a liquid crystal display (LCD) element irradiated with back light such as a light emitting diode (LED), an organic light emitting diode (OLED) element, and a two-dimensional image display element such as a display element in which a plurality of micro LEDs are arranged in a lattice shape on a plane.

In the head-mounted display 1 according to this exemplary embodiment, the diffraction optical member 30 displays an image on the retina of the eye of the user by deflecting (reflecting) the light emitted from the light source 10 via the scanning mirror 20.

The diffraction optical member 30 according to this exemplary embodiment suppresses entry of moisture into the hologram element as described later, and can thus suppress degradation of a deflection characteristic caused by moisture absorption by the hologram element. The diffraction optical member 30 will be described in detail below.

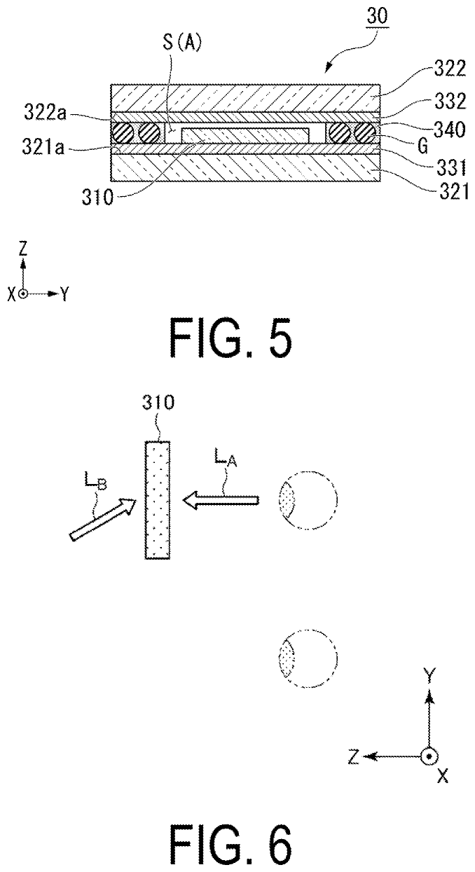

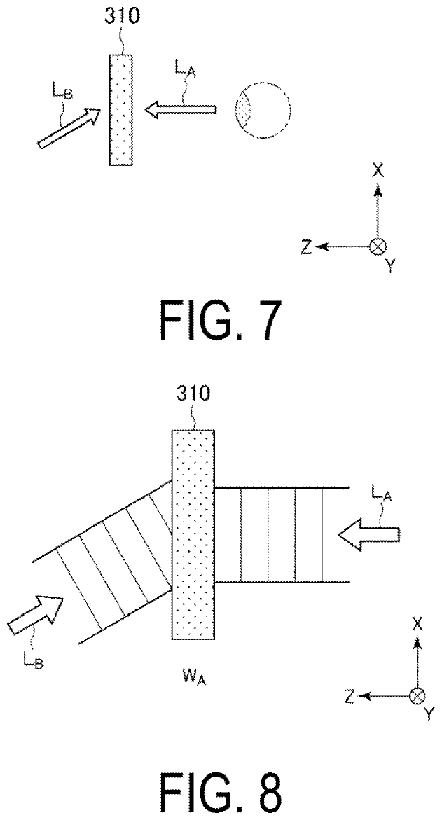

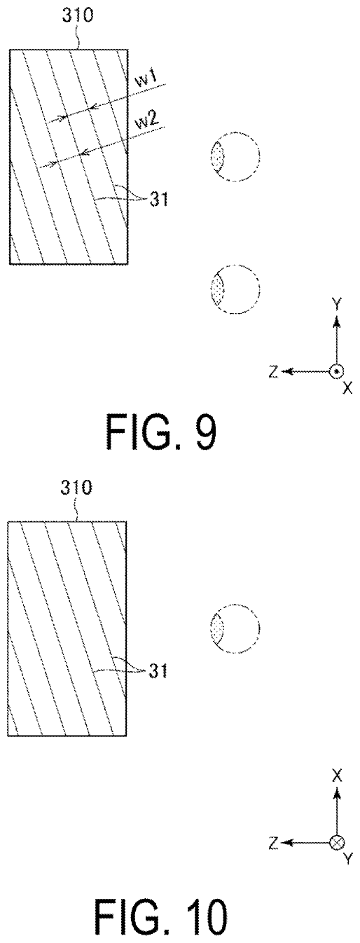

FIG. 5 is a cross-sectional view illustrating a schematic configuration of the diffraction optical member 30. FIG. 5 is a cross-sectional view taken along a plane along a YZ plane of the diffraction optical member 30. FIGS. 6 and 7 are diagrams illustrating a method for manufacturing the hologram element. FIG. 8 is a schematic view illustrating an exposure method for exposing the hologram element by using a plane wave. FIGS. 9 and 10 are schematic views illustrating a pattern of an interference stripe of the hologram element.

As illustrated in FIG. 5, the diffraction optical member 30 according to this exemplary embodiment includes a first substrate 321, a first dielectric film 331, a hologram element 310, a second substrate 322, a second dielectric film 332, and an adhesive member 340.

The first substrate 321 has moisture permeability.

As a material forming the first substrate 321, for example, a resin material such as polyethylene terephthalate, polyethylene naphthalate, polypropylene, cycloolefin polymer, polyamide, polyether sulfone, polymethyl methacrylate, polycarbonate, and polyalylate, and a glass material such as quartz glass and soda glass are exemplified. One, two or more kinds of those may be used in combination.

An average thickness of the first substrate 321 is not particularly limited, but the thickness may be approximately equal to or greater than 0.5 mm and equal to or less than 5 mm, more preferably, approximately equal to or greater than 0.7 mm and equal to or less than 2 mm. The first substrate 321 may be substantially transparent (colorless and transparent, colored and transparent, or semi-transparent).

The first dielectric film 331 is provided at an inner surface 321a of the first substrate 321. The first dielectric film 331 is a film functioning as a water vapor barrier layer that suppresses or prevents the entry of moisture into the first dielectric film 331, that is, into the hologram element 310 side through the first substrate 321 having the moisture permeability. The inner surface 321a corresponds to “one surface of the first substrate”. In this exemplary embodiment, the first substrate 321 supports the hologram element 310 via the first dielectric film 331.

The hologram element 310 is provided at the first dielectric film 331 provided at the inner surface 321a of the first substrate 321. The hologram element 310 displays an image on the retina of the eye of the user by deflecting incident light emitted from the light source 10, and has an upper surface and a lower surface both having a flat plate shape. The hologram element 310 according to this exemplary embodiment is formed of a volume hologram. The volume hologram includes a hologram layer and a transparent film layer.

The hologram element 310 according to this exemplary embodiment is formed of the volume hologram, and can thus diffract, at relatively high efficiency, the light entering the diffraction optical member 30.

The hologram element 310 formed of the volume hologram has a refractive index distribution inside a resin layer, and is formed of, for example, a planar interference stripe 31 formed of a low-refractive layer and a high-refractive layer as schematically illustrated in FIGS. 9 and 10.

In a case in which a general mirror is used, an advance direction of light can be changed only in a regular reflection direction. Meanwhile, when the diffraction optical member 30 including the hologram element 310 formed of the volume hologram described above is used, as illustrated in FIG. 3, a direction of the light can be changed, that is, the light can be deflected not only in the regular reflection direction but also in any direction. Further, as compared to a general mirror, downsizing of the hologram element 310 can be achieved and this results in downsizing of the diffraction optical member 30.

Further, as illustrated in FIG. 4, for example, the diffraction optical member 30 corresponding to the right eye RE is arranged right opposite to the right eye RE, and the hologram element 310 is designed such that light from the scanning mirror 20 is diffracted to turn into primary diffracted light L1 and enters the right eye RE. Note that the same applies to the diffraction optical member 30 corresponding to the left eye LE.

Further, in this exemplary embodiment, the scanning mirror 20 is arranged at a position other than a position in a plane (YZ plane) containing the Z axis perpendicular to the center of the eye and the Y axis coupling the centers of the eyes with each other. In this exemplary embodiment, the scanning mirror 20 is arranged at a height H being a position higher than the YZ plane (the height of the eye). Specifically, for example, when a pupil diameter is 4 mm, the scanning mirror 20 is arranged at the height H away from the center of the eye by at least 2 mm or more. Note that, for example, an upper limit of the height away from the center of the eye falls within a range enabling the head-mounted display 1 to function. With this arrangement, zero-order diffracted light LO among the incident light entering the hologram element 310 from the scanning mirror 20 advances in a direction at a height different from the left eye LE, and as a result, does not enter the left eye LE.

Meanwhile, the primary diffracted light L1 among the incident light entering the diffraction optical member 30 from the scanning mirror 20 enters the right eye RE. In this way, the image can be recognized. Note that directions of the zero-order diffracted light L0 and the primary diffracted light L1 can be adjusted by a configuration of an exposure optical system when the hologram element 310 is manufactured.

The hologram element 310 included in the diffraction optical member 30 as described above, that is, the volume hologram having the planar interference stripe 31 formed of the low-refractive layer and the high-refractive layer can be formed by, for example, interference exposure of two light fluxes containing object light LA and reference light LB (see FIGS. 6 and 7).

In other words, one surface of the hologram element 310 to be formed is exposed with the object light LA having a plane wave WA, and the other surface is exposed with the reference light LB having the plane wave WA so as to cross the object light LA (see FIG. 8). Further, an angle at which the object light LA and the reference light LB cross each other determines a characteristic of the formed hologram element 310 (the volume hologram).

Note that, as the exposure method, as illustrated in FIG. 8, an example using the plane wave WA is given. As described above, in a case of recording with the plane wave WA, as illustrated in FIG. 9, an angle of the interference stripe 31 of the hologram element 310 is recorded at an angle other than a perpendicular angle with respect to the Z axis in the hologram as a whole. Further, the plane wave WA is used, and thus the recorded interference stripe 31 is also linear (planar). Note that, in the exposure, in place of the plane wave WA illustrated in FIG. 8, a spherical wave can be used.

The interference stripe 31 illustrated in FIGS. 9 and 10 is a schematic view illustrating a photopolymer portion in an enlarged manner. In the interference stripes 31, the refractive index distribution appears in oblique lines. That is, the high-refractive layer and the low-refractive layer are alternately distributed. Further, a width w1 of the high-refractive layer and a width w2 of the low-refractive layer are substantially the same. The width of the interference stripe 31 is set to be, for example, approximately equal to or greater than 200 nm and equal to or less than 1500 nm.

As described above, the interference stripe 31 of the hologram element 310 is formed to be oblique when the interference stripe 31 is viewed from above (see FIG. 9) and from a side (see FIG. 10).

The second substrate 322 is provided facing the hologram element 310. As the second substrate 322, a substrate similar to the first substrate 321 can be used. In this exemplary embodiment, the second substrate 322 is formed of a material having the moisture permeability.

The second dielectric film 332 is provided at an inner surface 322a of the second substrate 322. The second dielectric film 332 is a film functioning as a water vapor barrier layer that suppresses or prevents the entry of moisture into the hologram element 310 side through the second substrate 322 having the moisture permeability. The second dielectric film 332 has a configuration similar to that of the first dielectric film 331. Note that the inner surface 322a corresponds to a “surface of the second substrate facing the hologram element”.

The adhesive member 340 adheres the first substrate 321 to the second substrate 322. The adhesive member 340 according to this exemplary embodiment is formed of an adhesive after curing. The adhesive member 340 is arranged between the first substrate 321 and the second substrate 322 so as to surround a periphery of the hologram element 310 in a frame shape. The adhesive member 340 adheres the first dielectric film 331 provided at the first substrate 321 to the second dielectric film 332 provided at the second substrate 322.

Note that, in the first substrate 321 and the second substrate 322, the first dielectric film 331 and the second dielectric film 332 may not be selectively formed in a contact region by the adhesive member 340.

The adhesive member 340 forms an accommodation space S that accommodates the hologram element 310 by adhering the first substrate 321 to the second substrate 322. In other words, the accommodation space S is a space surrounded by the adhesive member 340, the first dielectric film 331, and the second dielectric film 332. In this exemplary embodiment, an air layer A is provided in the accommodation space S.

The adhesive member 340 according to this exemplary embodiment includes a gap member G. The gap member G is formed of a plurality of particles having a predetermined diameter, and a gap between the first substrate 321 and the second substrate 322 is defined as a predetermined value.

The particles having strength greater than that of the first substrate 321 and the second substrate 322 are used as the gap member G. In this way, a crack, a chip, and the like are less likely to occur in the gap member G even in a state where the gap member G is pressed between the first substrate 321 and the second substrate 322.

The diffraction optical member 30 according to this exemplary embodiment can easily achieve a structure in which the gap between the first substrate 321 and the second substrate 322 is held constant by using the adhesive member 340 including the gap member G. In this way, in the diffraction optical member 30, the first substrate 321 and the second substrate 322 are arranged substantially in parallel, and thus an occurrence of distortion in a surface shape can be suppressed. Thus, the diffraction optical member 30 has little distortion in the surface shape, and thus a see-through image through the diffraction optical member 30 has also little distortion and excellent visibility.

Note that a constituting material of the adhesive member 340 is not particularly limited as long as the constituting material can provide an adhesive property. However, there is an exemplified transparent material selected from, for example, an acrylic resin (adhesive), a silicon resin (adhesive), a polyester resin (adhesive), an urethane resin (adhesive), a polyvinyl acetate resin (adhesive), and the like. Note that an ultraviolet-curable type material is used as the constituting material of the adhesive member 340 according to this exemplary embodiment as described later.

In this exemplary embodiment, a constituting material of the first dielectric film 331 and the second dielectric film 332 is not particularly limited as long as the constituting material is dielectric and can provide a water vapor barrier property and transparency. For example, an inorganic material such as a ceramic material and a glass material, a resin material, and the like are exemplified, and one, two or more kinds of those can be used in combination. Particularly, a film that securely provides the above-mentioned water vapor barrier property and transparency can be formed by using the ceramic material.

As the ceramic material, for example, alumina, zirconia, magnesia, silica, silicon monoxide, titania, hafnium oxide, aluminum nitride, silicon nitride, silicon carbide, and barium titanate are exemplified, and one, two or more kinds of those may be used in combination. Of those, silicon monoxide (SiO), silica (SiO₂), alumina (Al₂O₃), hafnium oxide (HfO₂), zirconia (ZrO₂), and titania (TiO₂) may be preferably used. With those materials, the above-mentioned effects obtained through use of the ceramic material can be exerted more prominently. Further, the first dielectric film 331 and the second dielectric film 332 formed of the ceramic material can be relatively easily formed by a vacuum evaporation method, sputtering, ion plating, and a vapor growth method such as a plasma chemical vapor growth method.

Note that, as the glass material, for example, quartz glass and borosilicate glass are exemplified. Further, as the resin material, for example, polyvinyl chloride, polyethylene, polypropylene, polytetrafluoroethylene, polyethylene terephthalate, polyvinyl fluoride, an epoxy resin, and a phenol resin are exemplified.

Furthermore, the first dielectric film 331 and the second dielectric film 332 may be a single layer body and a multi-layer body formed of the above-mentioned constituting material, but may be preferably the multi-layer body. In this way, the above-mentioned function as the water vapor barrier layer as the first dielectric film 331 and the second dielectric film 332 can be more prominently exerted.

Note that, in a case in which the first dielectric film 331 and the second dielectric film 332 are the multi-layer body formed of the ceramic material, for example, a multi-layer body including a layer formed of silicon monoxide (SiO) and a layer formed of alumina (Al₂O₃), and having the layer formed of silicon monoxide (SiO) on the substrate side, or a multi-layer body including a layer formed of silicon monoxide (SiO) and a layer formed of hafnium oxide (HfO₂), and having the layer formed of silicon monoxide (SiO) on the substrate side can be used as the dielectric film.

An average thickness of the first dielectric film 331 and the second dielectric film 332 is not particularly limited, but the thickness may be approximately equal to or greater than 50 nm and equal to or less than 1 μm, more preferably, approximately equal to or greater than 100 nm and equal to or less than 300 nm. When the average thickness is less than the lower limit value described above, there is a risk that a sufficient water vapor barrier property cannot be provided depending on a kind of the constituting material. Furthermore, when the average thickness exceeds the upper limit value, there is a risk that a film crack may occur depending on a kind of the constituting material.

Further, water vapor permeability of the first dielectric film 331 and the second dielectric film 332 may be, for example, equal to or greater than 0.1 g/m²·24 hr (40° C., 90% RH) and equal to or less than 2.0 g/m²·24 hr (40° C., 90% RH), more preferably, equal to or greater than 0.1 g/m²·24 hr (40° C., 90% RH) and equal to or less than 1.0 g/m²·24 hr (40° C., 90% RH). With this, a function as a water vapor barrier layer that suppresses or prevents the entry of moisture (water vapor) into the hologram element 310 can securely be exerted.

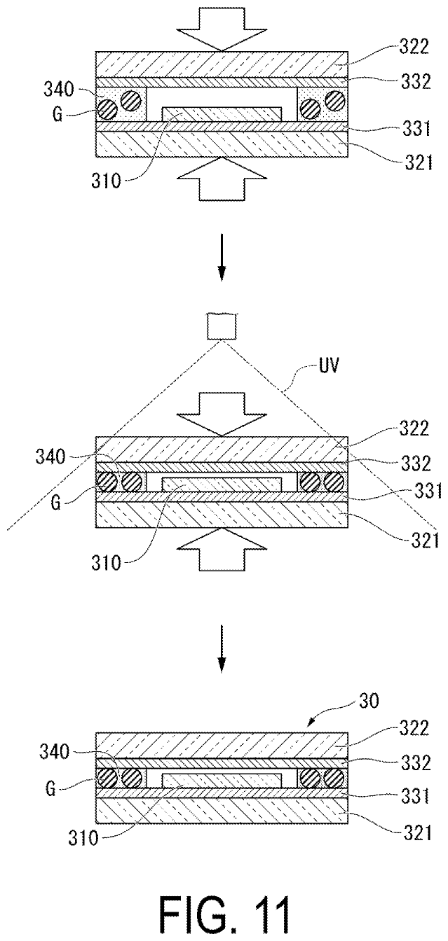

The diffraction optical member 30 according to this exemplary embodiment can be manufactured in the following steps. FIG. 11 is a diagram illustrating steps of manufacturing the diffraction optical member 30 according to this exemplary embodiment.

As illustrated in FIG. 11, in the diffraction optical member 30 according to this exemplary embodiment, for example, the first substrate 321 in which the hologram element 310 is formed via the first dielectric film 331, and the second substrate 322 on which the second dielectric film 332 is formed are bonded together in a glove box while the first substrate 321 and the second substrate 322 are pressed together with the adhesive member 340. At this time, the gap between the first substrate 321 and the second substrate 322 is held at a predetermined gap by the gap member G. Note that pressure in the glove box in which the first substrate 321 and the second substrate 322 are bonded together is set to be higher than atmospheric pressure, for example, equal to or greater than 0.1014 MPa.

Next, the adhesive member 340 is cured by irradiation by ultraviolet light UV while pressing the first substrate 321 and the second substrate 322. In this way, the first substrate 321 and the second substrate 322 are bonded together with a mutual gap defined at the predetermined value by the gap member G.

Note that, by providing an air emission groove in a part of the adhesive member 340, excessive air can be emitted from between the first substrate 321 and the second substrate 322. The air emission groove is crushed and closed when the adhesive member 340 is pressed. In this way, as illustrated in FIG. 5, the diffraction optical member 30 in which the hologram element 310 is accommodated in the accommodation space S including the air layer A can be manufactured.

Further, the head-mounted display 1 according to this exemplary embodiment can cause the user to observe the external world image as the see-through light. In the head-mounted display 1, a range that causes see-through light SL to be incident on the eye (an exit pupil SM) of the user is referred to as a see-through visual field range below.

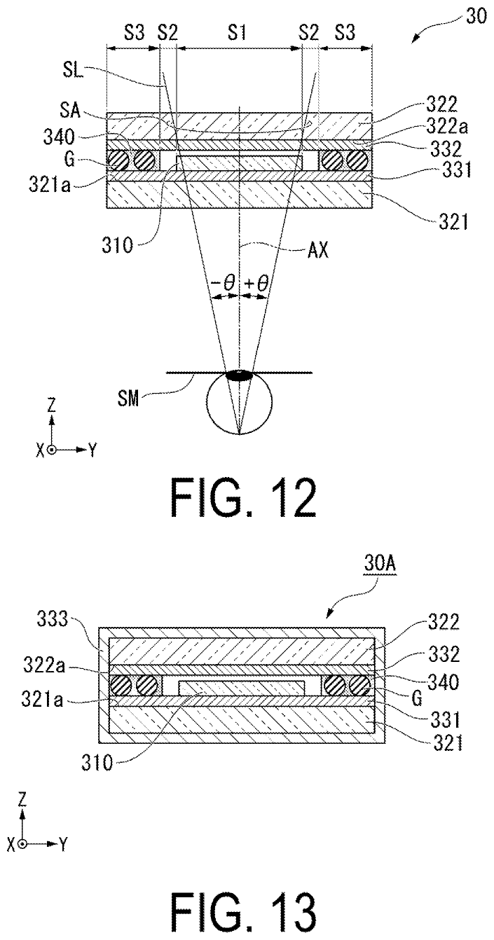

Here, a proportion (size) of the hologram element 310 that occupies the diffraction optical member 30 will be described. FIG. 12 is a diagram for illustrating the size of the hologram element 310 that occupies the diffraction optical member 30.

As illustrated in FIG. 12, the diffraction optical member 30 according to this exemplary embodiment includes a first region S1 in which the hologram element 310 is provided, a second region S2 in which the hologram element 310 is not provided, and a third region S3 in which the adhesive member 340 is provided in a left-right direction (Y direction). Note that the first region S1, the second region S2, and the third region S3 are located between the first substrate 321 and the second substrate 322, that is, between the first dielectric film 331 and the second dielectric film 332.

Here, when the second region S2 and the third region S3 are located within a see-through visual field range SA, there is a risk that distortion may occur in an image of the see-through light SL, and the see-through light SL cannot be visually recognized in an excellent manner.

Meanwhile, in the head-mounted display 1 according to this exemplary embodiment, the size of the hologram element 310 is set to be larger than the see-through visual field range SA through which the see-through light SL entering the exit pupil SM through the diffraction optical member 30 passes.

Specifically, in the head-mounted display 1 according to this exemplary embodiment, the size of the hologram element 310 is set so as to be located outside a see-through visual field half angle θ defined by an angle formed between the see-through visual field range SA in the left-right direction (Y direction) and an optical axis AX. Note that the size of the see-through visual field half angle θ described above is generally set to be ±30 degrees with respect to the optical axis AX.

As described above, in the head-mounted display 1 according to this exemplary embodiment, the second region S2 and the third region S3 are not located in the see-through visual field range SA, and only the first region S1 is located in the see-through visual field range SA. Thus, distortion does not occur in the image of the see-through light SL, and the see-through light SL can be visually recognized in an excellent manner.

For example, when the hologram element 310 formed of the volume hologram having the interference stripe 31 formed by the interference exposure as described above is formed directly on the first substrate 321 without providing the first dielectric film 331 and the second dielectric film 332, the following problem arises.

Since the first substrate 321 has the moisture permeability as described above, and thus the moisture that permeates the first substrate 321 enters the volume hologram. As a result, there is a problem that a position of the interference stripe is shifted due to expansion of the volume hologram, and a deflection characteristic of the volume hologram is degraded.

In contrast, the diffraction optical member 30 according to this exemplary embodiment includes the first dielectric film 331 provided between the first substrate 321 and the hologram element 310, and the second dielectric film 332 provided at the inner surface 322a on the second substrate 322 side facing the hologram element 310. The first dielectric film 331 can function as the water vapor barrier layer that suppresses or prevents the entry of moisture through the first substrate 321 into the hologram element 310 side supported by the first substrate 321, and the second dielectric film 332 can function as the water vapor barrier layer that suppresses or prevents the entry of moisture through the second substrate 322 into the accommodation space S that accommodates the hologram element 310.

Thus, the diffraction optical member 30 according to this exemplary embodiment can properly suppress or prevent the entry of moisture into the hologram element 310, and can properly suppress or prevent degradation of a deflection characteristic of the hologram element 310 due to the expansion of the hologram element 310 and a shift in the position of the interference stripe 31. Further, the diffraction optical member 30 according to this exemplary embodiment can properly suppress or prevent degradation of moisture absorption degradation due to moisture absorption by the hologram element 310.

Further, the diffraction optical member 30 according to this exemplary embodiment includes the adhesive member 340 that adheres the first substrate 321 to the second substrate 322 so as to form the accommodation space S that accommodates the hologram element 310. Thus, the adhesive member 340 is not directly in contact with the hologram element 310.

Here, in a case in which the adhesive member 340 and the hologram element 310 are in contact, moisture in the adhesive member 340 and a material component such as a diluent used in the adhesive member 340 damage the volume hologram constituting the hologram element 310, and cause a fluctuation in deflection characteristic of the hologram element 310.

In contrast, since the adhesive member 340 is not in contact with the hologram element 310 as described above in the diffraction optical member 30 according to this exemplary embodiment, the diffraction optical member 30 can properly suppress or prevent a fluctuation in deflection characteristic of the hologram element 310 caused by contact with the adhesive member 340. Further, the diffraction optical member 30 according to this exemplary embodiment can properly suppress or prevent degradation of moisture absorption due to moisture absorption by the hologram element 310 caused by contact with the adhesive member 340.

### Second Exemplary Embodiment

Next, a diffraction optical member according to a second exemplary embodiment will be described. A difference between the diffraction optical member according to the second exemplary embodiment and the diffraction optical member 30 according to the first exemplary embodiment will be mainly described, and the description on the same matter will be omitted below.

FIG. 13 is a cross-sectional view illustrating a schematic configuration of a diffraction optical member 30A according to the second exemplary embodiment.

As illustrated in FIG. 13, the diffraction optical member 30A according to this exemplary embodiment includes a first substrate 321, a first dielectric film 331, a hologram element 310, a second substrate 322, a second dielectric film 332, an adhesive member 340, and a third dielectric film 333.

The diffraction optical member 30A according to this exemplary embodiment has a configuration common to the diffraction optical member 30 except that the diffraction optical member 30A includes the third dielectric film 333 covering the entire periphery of the diffraction optical member 30 according to the first exemplary embodiment. In other words, the third dielectric film 333 is provided at an outer surface of the first substrate 321 and the second substrate 322 so as to surround a periphery of the hologram element 310.

The third dielectric film 333 has a configuration similar to that of the first dielectric film 331 and the second dielectric film 332. In other words, the third dielectric film 333 is a film functioning as a water vapor barrier layer that suppresses or prevents the entry of moisture in the atmosphere into the first substrate 321 and the second substrate 322.

Note that, in the diffraction optical member 30A according to this exemplary embodiment, the second dielectric film 332 may be omitted as necessary.

The diffraction optical member 30A according to this exemplary embodiment includes the third dielectric film 333 covering the outer surface of the first substrate 321 and the second substrate 322, and can thus obtain the following effect in addition to the effect of the first exemplary embodiment. Specifically, the diffraction optical member 30A according to this exemplary embodiment can suppress or prevent, by the third dielectric film 333, the entry of moisture in the atmosphere into the first substrate 321 and the second substrate 322. Thus, the diffraction optical member 30A according to this exemplary embodiment can more effectively suppress or prevent degradation of moisture absorption due to moisture absorption by the hologram element 310.

### Third Exemplary Embodiment

Next, a diffraction optical member according to a third exemplary embodiment will be described. A difference between the diffraction optical member according to the third exemplary embodiment and the diffraction optical member 30 according to the first exemplary embodiment will be mainly described, and the description on the same matter will be omitted below.

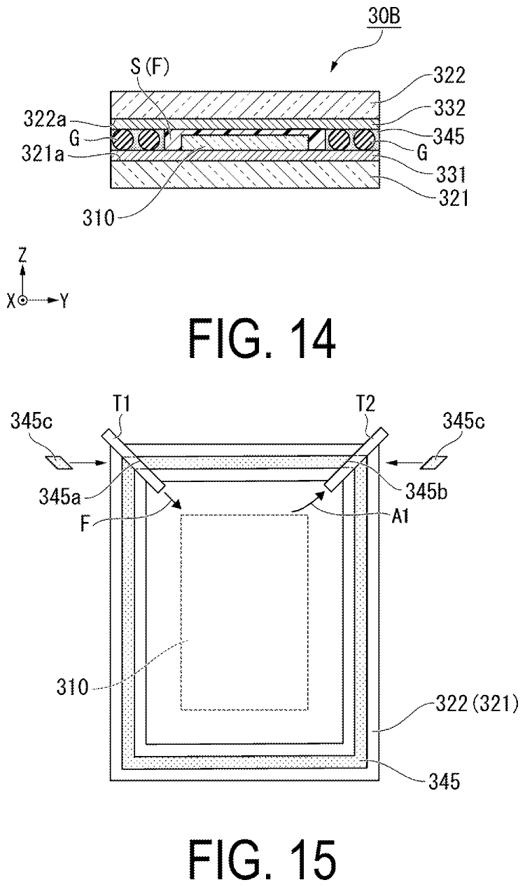

FIG. 14 is a cross-sectional view illustrating a schematic configuration of a diffraction optical member 30B according to the third exemplary embodiment.

As illustrated in FIG. 14, the diffraction optical member 30B according to this exemplary embodiment includes a first substrate 321, a first dielectric film 331, a hologram element 310, a second substrate 322, a second dielectric film 332, and an adhesive member 345.

In the diffraction optical member 30B according to this exemplary embodiment, an inert substance F is provided in an accommodation space S. The inert substance F includes an inert gas or an inert liquid. For example, N2, He, Ne, Ar, Kr, Xe, or mixed gas thereof can be used as the inert gas. Further, for example, fluorine-based inert liquid can be used as the inert liquid.

Note that a structure in which the inert liquid as the inert substance F fills the accommodation space S is manufactured by a step illustrated in FIG. 15. For example, as illustrated in FIG. 15, when the first substrate 321 and the second substrate 322 are bonded together, the adhesive member 345 having a first opening 345a and a second opening 345b is used. The first opening 345a is an opening for injection of the inert liquid as the inert substance F into the accommodation space S. The second opening 345b is an opening for emission of an air A1 from the inside of the accommodation space S when the inert liquid is injected into the accommodation space S.

Further, the air A1 inside the accommodation space S is emitted through the second opening 345b while injecting the inert liquid as the inert substance F into the accommodation space S through the first opening 345a. After injection processing of the inert liquid is completed, another adhesive member 345c applied to the first opening 345a and the second opening 345b is irradiated with the ultraviolet light UV and is cured to close the first opening 345a and the second opening 345b. The diffraction optical member 30B according to this exemplary embodiment is manufactured by the step described above.

According to the diffraction optical member 30B according to this exemplary embodiment, since the inert substance F is provided in the accommodation space S that accommodates the hologram element 310, there is no air inside the accommodation space S. In this way, the moisture absorption by the hologram element 310 due to slight moisture contained in the air can be prevented. Thus, a fluctuation in deflection characteristic of the hologram element 310 caused by moisture adsorption can be more effectively prevented.

### Fourth Exemplary Embodiment

Next, a diffraction optical member according to a fourth exemplary embodiment will be described. A difference between the diffraction optical member according to the fourth exemplary embodiment and the diffraction optical member 30 according to the first exemplary embodiment will be mainly described, and the description on the same matter will be omitted below.

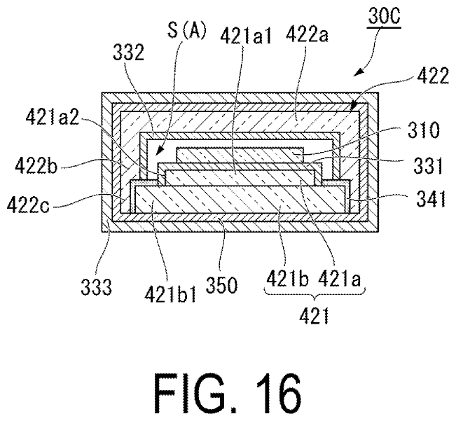

FIG. 16 is a cross-sectional view illustrating a schematic configuration of a diffraction optical member 30C according to the fourth exemplary embodiment.

As illustrated in FIG. 16, the diffraction optical member 30C according to this exemplary embodiment includes a first substrate 421, a first dielectric film 331, a hologram element 310, a second substrate 422, a second dielectric film 332, an adhesive member 341, a third dielectric film 333, and a hard coat layer 350. In the diffraction optical member 30C according to this exemplary embodiment, the second dielectric film 332 may be omitted as necessary.

The first substrate 421 includes a hologram support portion 421a and a fixing portion 421b. The hologram support portion 421a supports the hologram element 310 via the first dielectric film 331. The fixing portion 421b is integrally provided with the hologram support portion 421a. The fixing portion 421b includes a protruding portion 421b1 protruding to the outside of the hologram support portion 421a. The first dielectric film 331 is provided so as to cover an upper surface 421a1 and a side surface 421a2 of the hologram support portion 421a.

The second substrate 422 includes a top plate portion 422a, a side plate portion 422b, and a protruding portion 422c. The top plate portion 422a is a portion facing the hologram element 310. The side plate portion 422b is a portion in a frame shape extending from an inner surface of the top plate portion 422a toward the hologram element 310 side. The protruding portion 422c is provided at a tip of the side plate portion 422b in the −Z direction. In the left-right direction (Y direction), a wall thickness of the protruding portion 422c is thinner than a wall thickness of the side plate portion 422b.

In this exemplary embodiment, the first substrate 421 and the second substrate 422 can be engaged. Specifically, the protruding portion 421b1 of the first substrate 421 and the protruding portion 422c of the second substrate 422 are engaged. The first substrate 421 includes the protruding portion (a first engaging portion) 421b1 engaged with the second substrate 422, and the second substrate 422 includes the protruding portion (a second engaging portion) 422c engaged with the first substrate 421.

In the diffraction optical member 30C according to this exemplary embodiment, the second substrate 422 in a lid shape can fit over the first substrate 421. In the diffraction optical member 30C according to this exemplary embodiment, mechanical strength is improved by the first substrate 421 fitting into the second substrate 422, and thus deformation due to external force is less likely to occur. Thus, the diffraction optical member 30C according to this exemplary embodiment can reduce distortion of a see-through image caused by the deformation due to the external force.

In this exemplary embodiment, the adhesive member 341 adheres the first substrate 421 to the second substrate 422 by adhering the protruding portion 421b1 to the protruding portion 422c. Note that, when a structure in which the second substrate 422 can fit over the first substrate 421 is adopted, management of the gap between the first substrate 421 and the second substrate 422 is relatively easy. Thus, the gap member can be omitted from the adhesive member 341 according to this exemplary embodiment.

In the diffraction optical member 30C according to this exemplary embodiment, an accommodation space S is formed of a space surrounded by the adhesive member 341, the first dielectric film 331, and the second dielectric film 332. In this exemplary embodiment, an air layer A is provided in the accommodation space S. Note that an inert substance F in place of the air layer A may be provided in the accommodation space S.

The hard coat layer 350 is provided so as to cover the entire surface of a box body 450 formed of the first substrate 421 and the second substrate 422. The hard coat layer 350 contains a resin material, and can be formed by using a composition (hard coat material) containing, for example, an organic silicon compound (silane coupling agent) and a metallic oxide.

The organic silicon compound is not particularly limited. However, the organic silicon compound expressed in, for example, a general expression (1): (R¹)ₙSi(X¹)₄₋ₙ (in the general expression (1), R¹, X¹, and n indicate an organic group including two or more carbons having a polymerizable functional group, a hydrolyzable group, and an integer of one or two, respectively) is used.

Further, the metallic oxide is not particularly limited. However, for example, the oxides of metal such as Al, Ti, Sb, Zr, Si, Ce, Fe, In, Sn, and Zn are exemplified, and one, two or more kinds of those oxides may be used in combination. Of those, particularly, TiO₂, ZrO₂, CeO₂, ZnO₂, SnO₂, and ITO (indium-tin compound oxide) may be preferably used. The amount of those metallic oxides contained in the hard coat layer 350 is suitably set, and thus a refractive index of the hard coat layer 350 can be set to have a desired index.

Further, an average thickness of the hard coat layer 350 may be, for example, approximately equal to or greater than 1 μm and equal to or less than 50 μm, more preferably, approximately equal to or greater than 5 μm and equal to or less than 30 μm.

Note that the hard coat layer 350 can be formed by supplying a liquid composition (hard coat material) to the box body 450 and then performing drying. Further, as a method for supplying the composition described above to the box body 450, for example, a method for immersing the box body 450 in the composition (immersion method), a method for showering (atomizing) the composition on the box body 450 (atomization method), a method for applying the composition to the box body 450 (application method), and the like are exemplified. Of all, the immersion method may be preferably used. In this way, the hard coat layer 350 having a uniform thickness can be formed simultaneously.

Further, in addition to the organic silicon compound and the metallic oxide, the composition (hard coat material) may contain an ultraviolet-curable type curative agent. In this case, the hard coat layer 350 can be formed by drying the liquid composition on the box body 450 and then irradiating the composition with UV light.

Furthermore, a liquid repelling film formed of a fluorine-based material, a silicon-based material, and the like may be provided at a surface of the third dielectric film 333. In this way, a liquid resistance property of the diffraction optical member 30C against water and the like can be improved.

The third dielectric film 333 is provided so as to cover a periphery of the hard coat layer 350. In this exemplary embodiment, the third dielectric film 333 may be provided with a function as an anti-reflection film. In a case in which the third dielectric film 333 is provided with the function as the anti-reflection film, the third dielectric film 333 may be formed of a multi-layer body formed of the ceramic material. Specifically, for example, there is exemplified a multi-layer body including a layer formed of silicon monoxide (SiO), a layer formed of zirconia (ZrO₂), a layer formed of silica (SiO₂), a layer formed of titania (TiO₂), a layer formed of zirconia (ZrO₂), and a layer formed of silica (SiO₂), and the layer formed of silicon monoxide (SiO) is on a hard coat layer 350 side.

Further, in this case, an average thickness of the third dielectric film 333 is suitably set so as to exert the function as the anti-reflection film, and the thickness may be, for example, approximately equal to or greater than 100 nm and equal to or less than 500 nm, more preferably, approximately equal to or greater than 300 nm and equal to or less than 500 nm.

As described above, in addition to the effect similar to that of the first exemplary embodiment described above, the diffraction optical member 30C according to this exemplary embodiment has improved mechanical strength by fitting the first substrate 421 into the second substrate 422, and can thus reduce distortion of a see-through image caused by the deformation due to the external force.

Further, the diffraction optical member 30C according to this exemplary embodiment can improve adhesion between the box body 450 and the third dielectric film 333 by the hard coat layer 350 interposed between the box body 450 and the third dielectric film 333.

Note that the technical scope of the present disclosure is not limited to the above-described exemplary embodiments, and various modifications can be made to the above-described exemplary embodiments without departing from the spirit and gist of the present disclosure.

For example, in the exemplary embodiments described above, a case in which the hologram element 310 is formed of the volume hologram is exemplified as an example, but the hologram element 310 may be a surface relief hologram, a blazed diffraction grating, and the like in addition to the volume hologram.

Further, in the exemplary embodiments described above, a case in which each of the first substrate 321 and the hologram element 310 has a planar upper surface and a planar lower surface being a parallel planar plate is described. However, at least one of the first substrate 321 and the hologram element 310 may have any of or both of the upper surface and the lower surface being a curved surface. Further, the second substrate 322 may have a curved shape.

Further, in a case in which the virtual image display device according to the present disclosure is applied to a virtual reality type head-mounted display such as VR and the like, and the second substrate 322 is not required to be transparent, a non-transparent substrate can be used as the second substrate 322. Note that, as the non-transparent substrate, for example, a substrate formed of the ceramic material such as alumina, a substrate obtained by forming an oxide film (insulating film) on a surface of a metal substrate such as stainless steel, and the like are exemplified.

Further, in the exemplary embodiments described above, a case in which the virtual image display device (image display device) including the diffraction optical member according to the present disclosure is applied to the head-mounted display (HMD) is described as an example. However, the present disclosure is not limited thereto. The virtual image display device including the diffraction optical member according to the present disclosure may also be applied to a head-up display fixed to an object and a binocular type hand-held display.

In addition, a specific description of the diffraction optical member and the virtual image display device such as shape, number, arrangement, material and the like of each component is not limited to the exemplary embodiments described above, and may be suitably changed.

A diffraction optical member according to an aspect of the present disclosure may have the following configuration.

A diffraction optical member according to a first aspect of the present disclosure includes a first substrate having moisture permeability, a first dielectric film provided at one surface of the first substrate, a hologram element provided at the first dielectric film, a second substrate provided facing the hologram element, and an adhesive member configured to adhere the first substrate to the second substrate to form an accommodation space that accommodates the hologram element.

The diffraction optical member according to the first aspect of the present disclosure may further include a second dielectric film provided at a surface of the second substrate facing the hologram element, the second substrate may having moisture permeability.

A diffraction optical member according to a second aspect of the present disclosure includes a first substrate, a first dielectric film provided at one surface of the first substrate, a hologram element provided at the first dielectric film, a second substrate provided facing the hologram element, a second dielectric film provided at a surface of the second substrate facing the hologram element, and an adhesive member configured to adhere the first substrate to the second substrate to form an accommodation space that accommodates the hologram element, where at least one of an inert substance and an air layer is provided in the accommodation space.

In the diffraction optical member according to the aspect described above of the present disclosure, the inert substance may be an inert gas or an inert liquid.

In the diffraction optical member according to the aspect described above of the present disclosure, the inert substance may be an inert gas or an inert liquid.

The diffraction optical member according to the aspect described above of the present disclosure may further include a third dielectric film provided at an outer surface of the first substrate and the second substrate so as to surround a periphery of the hologram element.

In the diffraction optical member according to the aspect described above of the present disclosure, the adhesive member may include a gap member configured to define a gap between the first substrate and the second substrate.

In the diffraction optical member according to the aspect described above of the present disclosure, the first substrate may include a first engaging portion configured to engage with the second substrate, the second substrate may include a second engaging portion configured to engage with the first substrate, and the adhesive member may adhere the first engaging portion to the second engaging portion.

A virtual image display device according to an aspect of the present disclosure may have the following configuration.

A virtual image display device according to an aspect of the present disclosure includes the diffraction optical member according to the aspect described above of the present disclosure.

In the virtual image display device according to the aspect described above of the present disclosure, the size of the hologram element may be larger than a see-through visual field range through which see-through light entering an exit pupil through the diffraction optical member passes.

What is claimed is:

1. A diffraction optical member, comprising:
a first substrate having moisture permeability;
a first dielectric film provided at one surface of the first substrate;
a hologram element provided at the first dielectric film;
a second substrate provided facing the hologram element; and
an adhesive member configured to adhere the first substrate to the second substrate to form an accommodation space that accommodates the hologram element.

2. The diffraction optical member according to claim 1, further comprising
a second dielectric film provided at a surface of the second substrate facing the hologram element, wherein
the second substrate has moisture permeability.

3. A diffraction optical member, comprising:
a first substrate;
a first dielectric film provided at one surface of the first substrate;
a hologram element provided at the first dielectric film;
a second substrate provided facing the hologram element;
a second dielectric film provided at a surface of the second substrate facing the hologram element; and
an adhesive member configured to adhere the first substrate to the second substrate to form an accommodation space that accommodates the hologram element, wherein
at least one of an inert substance and an air layer is provided in the accommodation space.

4. The diffraction optical member according to claim 3, wherein
the inert substance is an inert gas.

5. The diffraction optical member according to claim 3, wherein
the inert substance is an inert liquid.

6. The diffraction optical member according to claim 1, further comprising
a third dielectric film provided at an outer surface of the first substrate and the second substrate so as to surround a periphery of the hologram element.

7. The diffraction optical member according to claim 1, wherein
the adhesive member includes a gap member configured to define a gap between the first substrate and the second substrate.

8. The diffraction optical member according to claim 1, wherein
the first substrate includes a first engaging portion configured to engage with the second substrate,
the second substrate includes a second engaging portion configured to engage with the first substrate, and
the adhesive member adheres the first engaging portion to the second engaging portion.

9. A virtual image display device comprising the diffraction optical member according to claim 1.

10. The virtual image display device according to claim 9, wherein
a size of the hologram element is larger than a see-through visual field range through which see-through light passes, the see-through light entering an exit pupil through the diffraction optical member.
